(19) United States
(12) Patent Application Publication
(10) Pub. No.: US 2025/0332972 A1
(43) Pub. Date: Oct. 30, 2025

(54) MOTOR VEHICLE SEAT, COMPRISING A REMOVABLE BACKREST MODULE

(71) Applicant: Faurecia Sièges d'Automobile, Nanterre (FR)

(72) Inventors: Xifan TAO, Wuhan (CN); Gwen HAZOUME, SAINT CYR LECOLE (FR)

(21) Appl. No.: 19/187,956

(22) Filed: Apr. 23, 2025

(30) Foreign Application Priority Data
Apr. 24, 2024 (FR) FR 24 04234

(51) Int. Cl. B60N 2/68

(52) U.S. Cl. CPC B60N 2/682; B60N 2002/684

(57) ABSTRACT

A motor vehicle seat having a structural frame that includes an upper cross-member, and a backrest module having a foam block and a support arranged below the foam block to support that foam block. The seat includes an upper locking element carrying the support and removably connected to the upper cross-member.

### TECHNICAL FIELD

The present invention relates to a motor vehicle seat, comprising a backrest module.

### BACKGROUND

In some cases, it may be necessary to remove the backrest module from the seat. Such a backrest module is usually integrated into the seat, so it is necessary to destroy certain parts of the seat to enable this removal.

### SUMMARY

One of the aims of the invention is to provide a seat whose backrest module can be taken off without destroying any parts of the seat.

To this end, an object of the invention is a motor vehicle seat, comprising a structural frame, comprising an upper cross-member, and a backrest module comprising a foam block and a support arranged under the foam block to support this foam block, characterised in that it comprises an upper locking element carrying the support and connected to the upper cross-member in a removable manner.

The backrest module is secured in the seat by the upper element, which is snap-fitted onto the cross-member of the seat's structural frame. In accordance with the invention, simply disengaging the snap-fit allows the upper element and the rest of the module to be removed without destroying any part of the seat.

In other beneficial aspects of the invention, the seat comprises one or more of the following features, taken in isolation or in any technically possible combination:
The support comprises rods provided with a hook at their upper end, each hook cooperating with a complementary notch carried by the upper element.
The upper element comprises a resiliently deformable arm configured to engage, for example by snap-fitting, on the cross-member.
The arm comprises a shoulder intended to come into contact with the cross-member in a locking position, and to be away from the cross-member in an unlocking position when the arm is resiliently deformed.
The backrest module further comprises a rear element, connected to the upper element, with the cross-member clamped between the arm in the locking position and the rear element.
The arm has a shoulder intended to engage the cross-member.
The arm has a ramp extending from the shoulder.
The arm has an elongated section forming a lever arm extending from the ramp.
The arm is accessible from the rear of the seat, for example through an opening in the rear element.
The seat comprises a flexible rear panel, the arm comprising a lever arm extending at least partially opposite the rear panel, so as to be accessible by deforming the flexible rear panel.
The arm is connected to the upper element by a resilient hinge.

### BRIEF DESCRIPTION OF THE DRAWINGS

The invention will appear more clearly when reading the description that follows, given solely as a non-limiting example and made in reference to drawings in which:

FIG. 1 is an exploded perspective view of part of a motor vehicle seat according to a first exemplary embodiment of the invention;

FIG. 2 is a longitudinal cross-section of a seat according to a second embodiment of the invention; and

FIG. 3 is a view similar to that of FIG. 2 of a seat according to a third embodiment of the invention.

### DETAILED DESCRIPTION

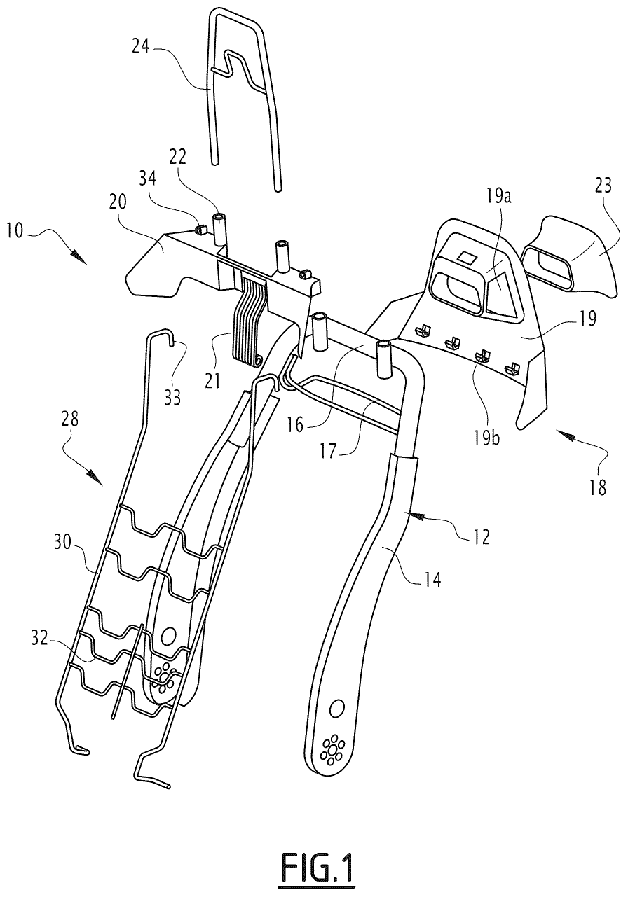

FIG. 1 shows part of a motor vehicle seat 10, and more particularly a backrest of that seat 10.

The backrest of the seat 10 has a structural frame 12 intended to support the components of the backrest.

The structural frame 12 comprises two side uprights 14, and an upper cross-member 16 extending transversely between the two uprights 14. In accordance with the first exemplary embodiment, the upper cross-member 16 has a circular cross-section.

Advantageously, the structural frame 12 further comprises at least one transverse rod 17, extending parallel to the upper cross-member 16 between the side uprights 14. The transverse rod 17 is intended to receive a rear panel 25 closing the seat 10 from the rear.

The backrest further comprises a backrest module 18, intended to be assembled with the structural frame 12.

The backrest module 18 comprises an upper locking element 20, intended to be locked to the structural frame 12.

The backrest module 18 further comprises a rear element 19, connected to the upper element 20, for example by snap-fitting.

The upper element 20 comprises an arm 21 configured to engage, for example to snap-fit, on part of the frame 12. The arm 21 is resiliently deformable to allow this engagement when the upper element 20 is inserted into the seat 10.

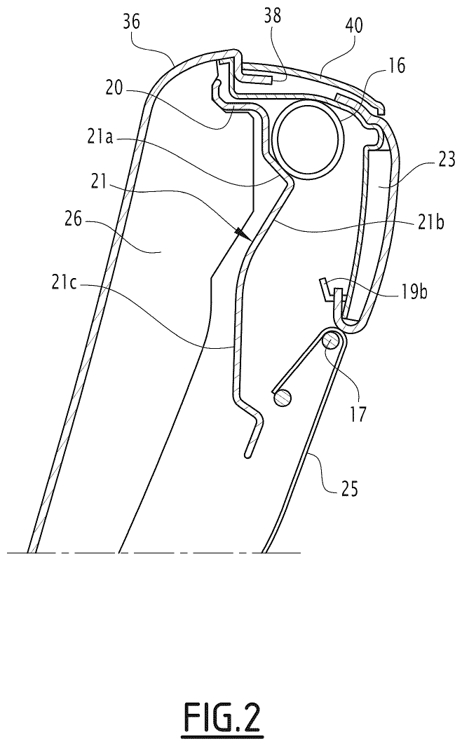

More specifically, the arm 21 has a shoulder 21a (visible in FIG. 2) intended to engage on the cross-member 16 of the frame 12.

The shoulder 21a is intended to come into contact with the cross-member 16 in a locking position, and to be away from the cross-member 16 in an unlocking position when the arm 21 is resiliently deformed.

The shoulder 21a is adjacent to a ramp 21b of the arm 21, preferably forming an angle greater than 90° with the shoulder 21a. Thus, when the upper element 20 is inserted into the seat 10, the ramp 21b comes into contact with the cross-member 16, and resiliently deforms the arm 21 until it passes the angle, after which the cross-member 16 rests on the shoulder 21a.

The arm 21 is configured to apply a resilient force to the cross-member 16 in the direction of the rear element 19. The cross-member 16 is thus clamped between the arm 21 and the rear element 19, as can be seen in FIG. 2. The arm 21 is then in the locking position.

The arm 21 also has an elongated part 21c forming a lever arm extending from the ramp 21b.

It should be noted that it is possible to disengage the arm 21 (unlocking position) by pushing the lever arm 21c in a direction away from the cross-member 16 to release the shoulder 21a of this cross-member 16, and thus allow the upper element 20 to be removed from the seat, without destroying any component of the seat or of the upper element 20.

To this end, in accordance with the first embodiment, the lever arm 21c is for example accessible from the rear of the seat 10, for example through an opening 19a provided in the rear element 19. Advantageously, a cover 23 closes the opening 19a. The cover 23 may be removable, or comprise an opening.

In a variant not shown, a strap is connected to the lever arm 21c, to enable the lever arm 21c to be operated by pulling the strap.

The upper element 20 comprises tubes 22 for receiving headrest rods 24. The receiving tubes 22 are conventional and will not be described further.

The backrest module 18 comprises a foam block 26 (visible in FIG. 2) and a support member 28 (visible in FIG. 1) intended to support this foam block 26. Note that the upper element 20 is positioned between the foam block 26 and the cross-member 16.

The support member 28 comprises two lateral rods 30, and transverse rods 32 extending between the two lateral rods 30 and together forming a support grid.

Each side rod 30 has, at its upper end, a hook 33 intended to cooperate with a complementary notch 34 formed in the upper element 20. In this way, the support member 28 is carried by the upper element 20.

The seat 10 further comprises a casing 36 covering the foam block 26. The rear element 19 has hooks 19b for securing the casing 36 to the rear of the seat 10.

In an upper part of the seat 10, the casing 36 comprises an upper passage opening 38 through which the backrest module 18, and in particular the upper element 20, can pass. The upper opening 38 is closed by a removable cover 40. The cover 40 has conventional through-holes for the headrest rods 24, facing the receiving tubes 22.

FIG. 2 shows a seat 10 according to a second exemplary embodiment. In this figure, elements similar to those in FIG. 1 are designated by identical references.

The seat 10 in the second embodiment is identical to that in the first embodiment, with the exception of the panel 25 which is flexible in the second embodiment, whereas it is either flexible or rigid in the first embodiment.

Thus, in accordance with the second embodiment, the arm 21, and more particularly the lever arm 21c, is accessible by pushing on the flexible panel 25 by deforming it to reach this lever arm 21c. To this end, the lever arm 21c is at least partly opposite the flexible panel 25.

It should be noted that access to the arm 21 via the opening 19a provided in the rear element 19, as described above for the first embodiment, is compatible with this second embodiment, so that the seat 10 can have both accesses, via the opening 19a or by deforming the flexible panel 25.

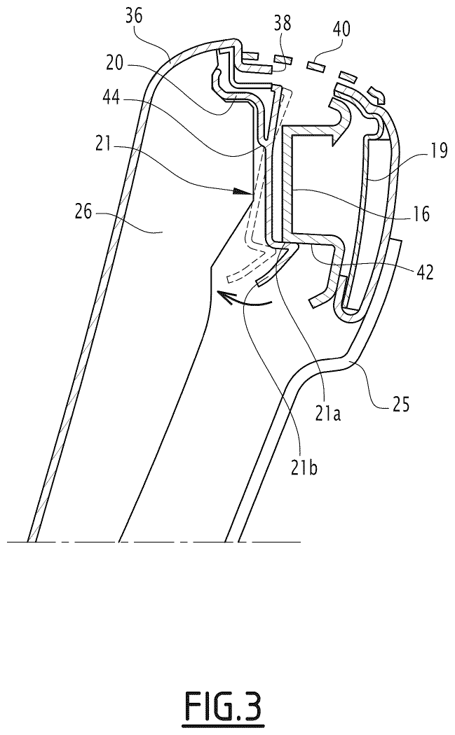

FIG. 3 shows a seat 10 according to a third exemplary embodiment. In this figure, elements similar to those in the previous figures are designated by identical references.

The seat 10 according to the third embodiment differs principally from those previously described in that the panel 25 is rigid. This panel 25 is then preferably removable, to allow access to the arm 21.

Alternatively, the panel 25 is not removable, but access to the arm 21 is via the opening 19a provided in the rear element 19, as described above for the first embodiment.

In this example, whereas the cross-member 16 has a circular cross-section in the first embodiment, the cross-member 16 in the third embodiment has a cross-section in the shape of a broken line, defining in particular a shoulder 42 intended to receive the complementary shoulder 21a of the arm 21.

The arm 21 is connected to the upper element 20 by a resilient hinge 44. The arm 21 is shorter than in the first embodiment, in particular because there is no lever arm 21c. Such a lever arm 21c is not necessary when access to the arm is not achieved by deforming a deformable rear panel.

In addition, the resilient hinge 44 makes it easier to operate the arm 21, which therefore does not require a larger lever arm.

It should be noted that this embodiment is compatible with the previous ones, i.e. a resilient hinge could be provided on the arm 21 of the first or second embodiment, with the shape of the arm 21 and cross-member 16 of the first embodiment.

The invention is not limited to the previously described embodiments, but could have additional variants without departing from the scope of the claims.

1. A seat for a motor vehicle, the seat comprising:
a structural frame comprising an upper cross-member, and
a backrest module including a foam block and a support arranged under the foam block to support this foam block,
wherein the seat comprises an upper locking element carrying the support and connected to the upper cross-member in a removable manner.

2. The seat according to claim 1, wherein the support comprises rods having an upper end and provided at their upper end with a hook, each hook cooperating with a complementary notch carried by the upper locking element.

3. The seat according to claim 1, wherein the upper locking element comprises a resiliently deformable arm configured to engage on the cross-member.

4. The seat according to claim 3, wherein the resiliently deformable arm is configured to engage on the cross member by snap-fitting.

5. The seat according to claim 3, wherein the resiliently deformable arm comprises a shoulder intended to come into contact with the cross-member in a locking position, and to be away from the cross-member in an unlocking position when the resiliently deformable arm is resiliently deformed.

6. The seat according to claim 3, wherein the backrest module further comprises a rear element, connected to the upper locking element, the cross-member being clamped between the resiliently deformable arm in the locking position and the rear element.

7. The seat according to claim 3, wherein the resiliently deformable arm has a shoulder intended to engage on the cross-member.

8. The seat according to claim 7, wherein the resiliently deformable arm comprises a ramp extending from the shoulder.

9. The seat according to claim 8, wherein the resiliently deformable arm comprises an elongate part forming a lever arm extending from the ramp.

10. The seat according to claim 6, wherein the resiliently deformable arm is accessible from the rear of the seat.

11. The seat according to claim 10, wherein the resiliently deformable arm is accessible through an opening provided in the rear element.

12. The seat according to claim 6, comprising a flexible rear panel, the resiliently deformable arm comprising a lever arm extending at least partially opposite the rear pane, so as to be accessible by deforming the flexible rear panel.

13. The seat according to claim 6, wherein the resiliently deformable arm is connected to the upper member by a resilient hinge.
